(19) United States
(12) Patent Application Publication
(10) Pub. No.: US 2003/0169726 A1
(43) Pub. Date: Sep. 11, 2003

(54) Connectionless routing of data within a telecommunication gateway

(76) Inventors: Gunnar Bengt Larsson, Tumba (SE); Patrik Wiss, Stockholm (SE); Lars-Goran Petersen, Tumba (SE); Ulf Ekstedt, Saltsjo-baden (SE)

Correspondence Address: NIXON & VANDERHYE, PC, 1100 N GLEBE ROAD, 8TH FLOOR, ARLINGTON, VA, 22201-4714, US

(21) Appl. No.: 10/312,522

(22) PCT Filed: Jun. 15, 2001
(86) PCT No.: PCT/SE01/01358

(51) Int. Cl. H04L 12/66; H04L 12/28; H04L 12/56

(52) U.S. Cl. 370/352; 370/401

(57) ABSTRACT

The invention concerns a telecommunication gateway for processing a data stream in a local chain of process function such as media stream applications (MSAs). The gateway basically includes a bearer control unit (102), a connection coordinator (103), and a resource manager (104) with an associated pool (105) of resources. For a requested connection, the connection coordinator (103) requests a media connection agent (106) and the necessary media stream applications (MSA1-MSA3) from the resource manager (104). The connection agent (106) determines a routing table (107) based on the destination addresses of the requested MSAs, and uses the routing table (107) to route the data stream from an incoming exchange terminal (ET1) to an outgoing exchange terminal (ET2) through the chain of MSAs.

### TECHNICAL FIELD OF THE INVENTION

The present invention generally relates to telecommunication systems, and more specifically to a telecommunication gateway for processing data streams in a local chain of process functions.

### BACKGROUND OF THE INVENTION

A telecommunication gateway is generally a device for processing or converting streams of information such as audio, video or other types of data between different networks. In particular, telecommunication gateways are often utilized for converting information streams provided in the format of one type of network to the format required in another type of network. The conversion is typically effectuated in a local chain of process functions within the relevant gateway.

An important type of gateway is the media gateway, which converts media streams such as audio or video streams between different networks.

FIG. 1 is a schematic diagram of a conventional media gateway for converting a media stream between two different networks. The media gateway 10 acts as an intermediary between two networks 20 and 30, and processes and/or converts a media stream in a local chain of process functions called media stream applications (MSAs) 40. The media gateway is controlled by a media gateway controller (MGC) 50. The MGC 50 terminates and analyzes the control signalling related to a call or connection, and controls the media gateway using some sort of control protocol in a conventional manner as described e.g. in the ITU-T Recommendation H.248 on Gateway Control Protocol. The media gateway is generally characterized by its ability to convert an incoming stream of data from network A to an outgoing stream of data towards network B, and the other way around. The media stream is usually the flow of data from one end user to another; e.g. voice or video. In a typical application, the media gateway converts data transferred between an access network and a core network. Examples of such networks are STM networks, ATM networks and IP-based networks. Furthermore, the media gateway normally has the ability to modify the media stream and even extract data from the stream. These abilities are provided by the media stream applications. The media stream applications (MSAs) are process functions included in the gateway as common resources that can be invoked as and when required. Examples of media stream applications are transcoding, echo cancellation, tone functions, dual tone multifrequency (DTMF) functions, conference call device (CCD) functions, announcement machine functions, modem functions, video transcoding and data transmission interworking (DTI).

FIG. 2 is a schematic diagram illustrating a physical view of a media stream chain in a conventional media gateway. The media gateway 10 is here built around a switch fabric 11. In a normal connection-oriented setup procedure, a connection from an incoming exchange terminal (ET1) through a chain of media stream applications (MSAs) to an outgoing exchange terminal (ET2) is established at call setup and kept for the duration of the call. This means that the necessary resources have to be reserved and maintained during the entire call. When the call has been completed, the connection and the associated resources are released.

FIG. 3 is a schematic diagram illustrating a logical view of a media stream chain in a conventional media gateway. The gateway comprises a bearer control unit 12, a connection coordinator 13, a resource manager 14 and a pool 15 of media stream application resources. The connection coordinator 13 is informed of an incoming request for a voice connection by the bearer control 12. The bearer control 12 indicates which exchange terminal ET1 that has been selected by the far end node, and also allocates an outgoing exchange terminal ET2. Next, the connection coordinator 13 requests a number of MSAs for the voice connection from the resource manager 14, and arranges the assigned MSAs in a chain of MSAs interconnected by user plane links. The chain carries media stream packets that traverse the switch fabric in the form of cells or packets depending on the particular type of switch fabric. For voice connections, codec and echo cancellation (EC) are typical examples of MSAs that are often required. In some situations, it may also be necessary to insert additional MSAs into the chain; e.g. when a tone has to be inserted into the media stream.

Each MSA typically has a number of service access points—an incoming access point and an outgoing access point for the user plane links, and an incoming access point and an outgoing access point for the control plane links to the media gateway controller (see FIG. 1). In addition, each MSA may have access points for modifying the operation of the MSA during the call. The service access points are also associated with information needed to address and find the resource in question. This information can normally be translated into physical references to a particular subrack, printed circuit board and processor, as well as a pointer to the actual software process to be executed by the indicated processor.

In order to setup a user plane link, the connection coordinator 13 has to acquire a service access point from the receiving MSA through an established control plane link, and transfer the acquired service access point to the transmitting side through another established control plane link. The procedure has to be repeated for all user plane links in the chain, and the established control plane links have to be maintained during the entire connection.

For the user plane link between the incoming exchange terminal ET1 and the codec application MSA1, the connection coordinator 13 acquires a service access point from the receiving codec application MSA1 through an established control plane link (1), and transfers the acquired service access point to the transmitting exchange terminal ET1 through another established control plane link (2). For the user plane link between MSAl and MSA2, the connection coordinator 13 acquires a service access point from the receiving echo cancellation (EC) application MSA2 through an established control plane link (3). The connection coordinator then transfers the acquired service access point to the transmitting codec application MSA1 through another established control plane link (4). The connection coordinator finally informs the last MSA (MSA2 or possibly MSA3 if a tone application needs to be inserted) of the allocated outgoing exchange terminal ET2 through an established control plane link (5). User plane links are indicated as horizontal links, and control plane links are indicated as vertical links.

When the connection is taken down, the connection coordinator releases the MSAs, and if necessary flushes stored states (some MSAs such as the echo cancellation application must store states and data from previous media stream packets to be able to process new ones).

It is also shown how a tone can be inserted during the call. The tone should be inserted in the user plane stream without disturbing the ongoing call. This is accomplished by splitting the chain between MSA2 and ET2, and introducing a tone application MSA3 using established control plane links (4′) and (5′). The connection coordinator 16 then acquires a service access point from the tone application MSA3 using the control plane link (4′) and transfers the service access point to the EC application MSA2 using the control plane link (5). Now, the control plane link (5′) is used for informing the tone application MSA3 of the allocated outgoing exchange terminal ET2.

Apparently, the conventional setup procedure is quite complex, and indeed requires a considerable amount of processing power. Although many MSA control plane links can be established during the start-up phase of the media gateway by means of a link handler provided by the operating system or some middleware on top of the operating system, a disadvantage of such a strategy is that the time required for restart will be quite long considering all the links that have to be established.

U.S. Pat. No. 5,600,640 discloses a call processing system for controlling connections in a communication system, and represents the state-of-the-art with respect to setup of ATM virtual connections.

### SUMMARY OF THE INVENTION

The present invention overcomes these and other drawbacks of the prior art arrangements.

It is a general object of the present invention to provide a telecommunication gateway with an efficient and robust mechanism for directing a stream of data through a local chain of process functions such as media stream applications.

In particular, it is desirable to reduce the time required for setup and takedown of a local connection chain in the gateway.

These and other objects are met by the invention as defined by the accompanying patent claims.

The general idea according to the invention is to introduce a connection agent for local routing of an incoming data stream through a local chain of process functions within the telecommunication gateway. The connection agent generally determines a local routing table that indicates how the stream shall be routed through the chain of process functions. In this way, the process functions do not have to be requested until they are really needed, and a new process function can easily be inserted into the chain of process functions by simply altering the routing table.

The solution according to the invention represents a “connectionless” strategy for directing data through a local chain of process functions. There is generally no process of setting-up a connection between source and destination before actually starting the transmission of data, and it is normally not necessary to maintain any call state information. The data packets in the stream are routed between source and destination only by means of the routing table of the connection agent and an individual address tag included in each packet. This results in a significant reduction of the time required for setup and takedown of the connection chain.

In a first preferred embodiment of the invention, the connection agent relays the data stream from one process function to the next, and the data actually flows back and forth between the connection agent and the various process functions. This generally means that the switch fabric has to transport virtually the same user data twice. In the currently most preferred embodiment, at least part of the routing table of the connection agent is therefore distributed to the process function level for allowing transfer of data more or less directly between the process functions.

The invention offers the following advantages:

Data streams are efficiently directed through a local chain of process functions in the gateway;

The time required for setup and takedown is significantly reduced; and

New process functions are flexibly inserted into the process function chain.

Other advantages offered by the present invention will be appreciated upon reading of the below description of the embodiments of the invention.

### BRIEF DESCRIPTION OF THE DRAWINGS

The invention, together with further objects and advantages thereof, will be best understood by reference to the following description taken together with the accompanying drawings, in which:

FIG. 1 is a schematic diagram of a conventional media gateway for converting a media stream between two different networks;

FIG. 2 is a schematic diagram illustrating a physical view of a media stream chain in a conventional media gateway;

FIG. 3 is a schematic diagram illustrating a logical view of a media stream chain in a conventional media gateway;

FIG. 4 is a schematic diagram illustrating a physical view of a media stream chain in a media gateway according to a preferred embodiment of the invention;

FIG. 5 is a schematic diagram illustrating a logical view of a media stream chain in a media gateway according to a preferred embodiment of the invention;

FIG. 6 is a schematic diagram of an example of a routing table and associated arrangements in a media connection agent according to a preferred embodiment of the invention;

FIG. 7 is a schematic diagram illustrating the connectionless routing protocol according to an exemplary embodiment of the invention from a packet viewpoint;

FIG. 8 is a schematic diagram illustrating an example of how the process resources can be accessed in a media gateway;

FIG. 9 is a schematic diagram illustrating a physical view of a media stream chain in a media gateway according to the currently most preferred embodiment of the invention;

FIG. 10 is a schematic diagram illustrating a logical view of a media stream chain in a media gateway according to an alternative embodiment of the invention.

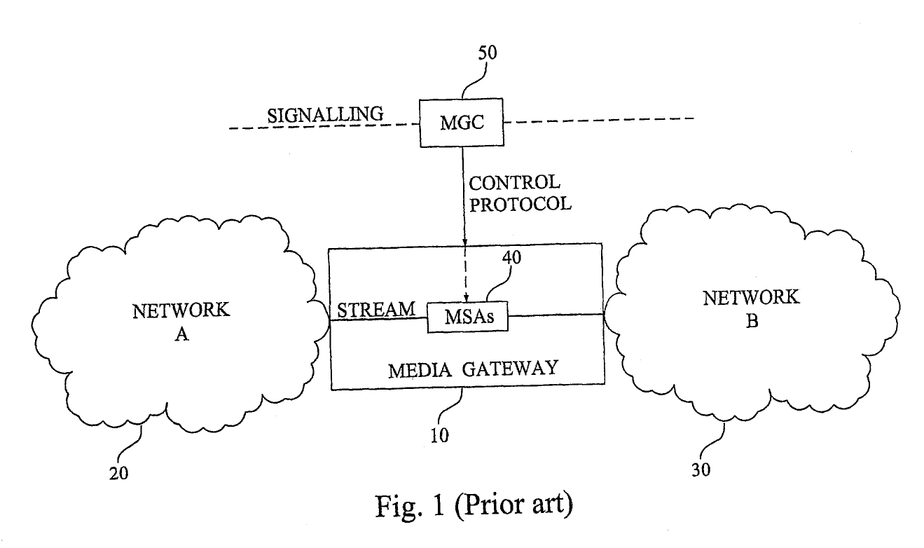

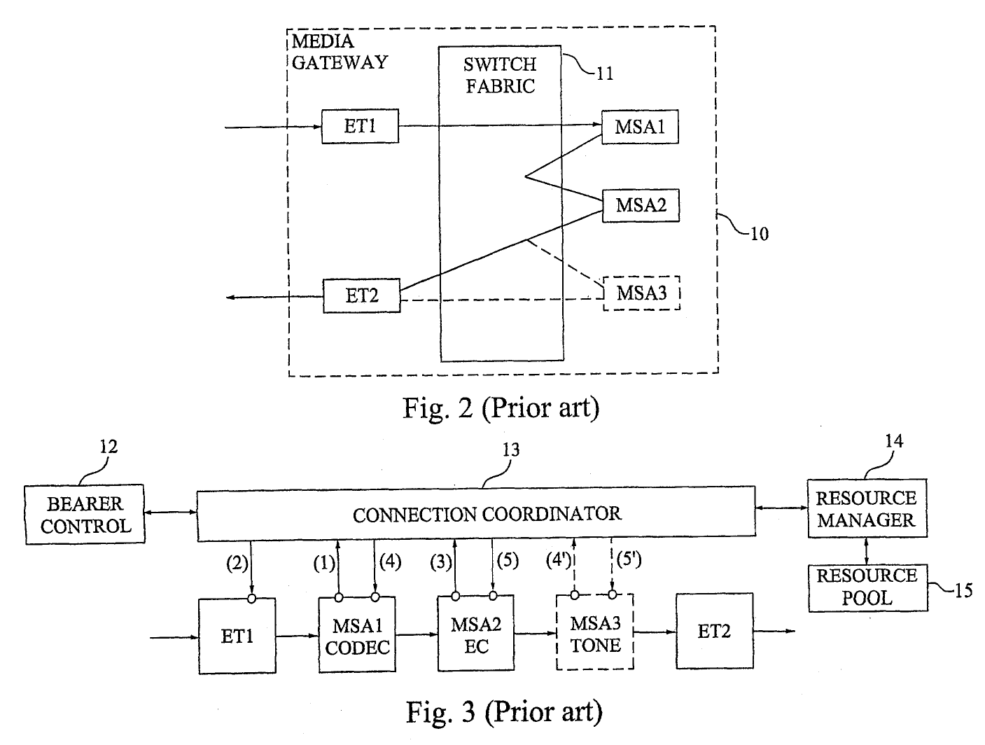

### DETAILED DESCRIPTION OF EMBODIMENTS OF THE INVENTION

Throughout the drawings, the same reference characters will be used for corresponding or similar elements.

The invention will now be described with reference to illustrative examples of a specific telecommunication gateway, namely a media gateway. However, the invention is not limited thereto, and it should be understood that the invention is applicable to any type of telecommunication gateway including the various gateways provided in radio network controllers and base stations.

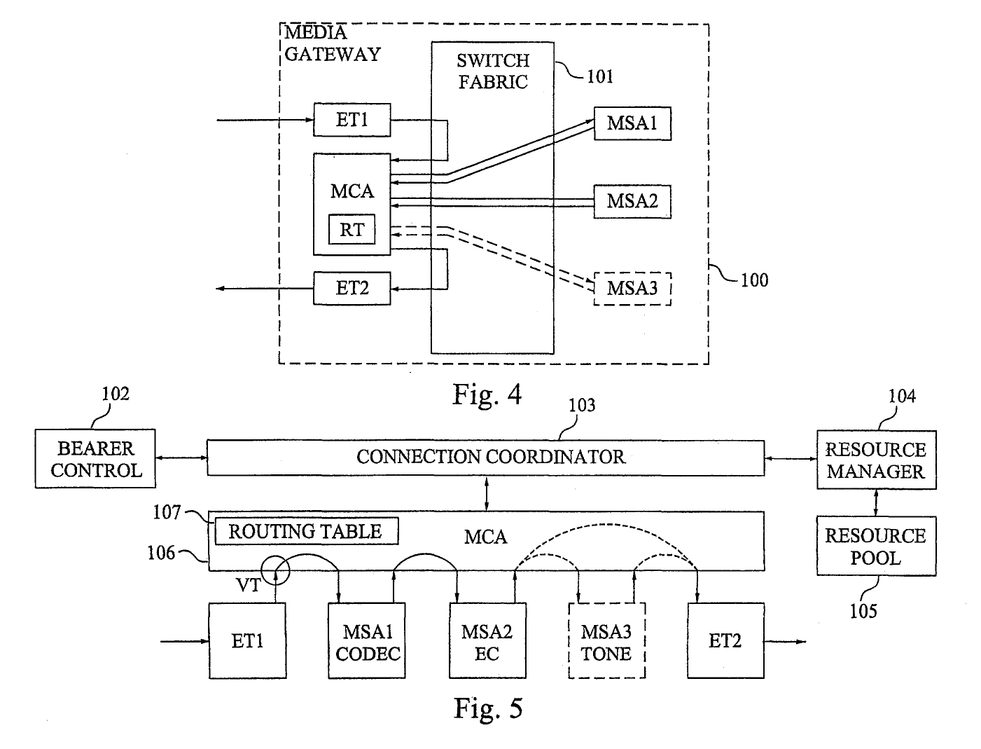

FIG. 4 is a schematic diagram illustrating a physical view of a media stream chain in a media gateway according to a preferred embodiment of the invention. Preferably, the media gateway 100 is built around a switch fabric 101. In general, the switch fabric 101 may be any conventional fabric such as a cell switching fabric or a packet switching fabric. In the following, however, the media gateway will be described as built around a cell switching fabric in which media stream packets will be segmented into cells before traversing the switch fabric. A media stream packet is generally confined to a single cell, but if the size of the media stream packet is larger than the fixed cell size, the packet may be arranged in several cells and reassembled at each MSA.

In the same way as for conventional media gateways, the overall operation of the media gateway is controlled by a media gateway controller (not shown). The gateway controller terminates and analyzes the control signalling related to a call, and controls the media gateway using a control protocol in a conventional manner. An example of a suitable control protocol is the ITU-T Recommendation H.248. The ITU-T Recommendation H.248 can also be referred to for a general introduction to media gateways.

However, for the establishment of a chain of media stream applications (MSAs) for a particular media stream, a connection chain agent is introduced for locally routing the media stream through the switch fabric to the different media stream applications in the MSA chain. The connection chain agent, here referred to as a connection agent or a media connection agent (MCA), basically determines a local routing table (RT) that indicates how the media stream shall be routed through the MSA chain, and effectuates the media stream routing based on the routing table. This means that the MSAs now only need to communicate with the media connection agent.

The main tasks of the media connection agent according to a preferred embodiment of the invention are summarized below:

Establishing a connection chain for a media stream by determining a routing table. The media connection agent normally appends its own source address to each outgoing cell so that the MSAs in the connection chain are aware of the address of the assigned connection agent.

Inserting, if required, new MSAs into the connection chain by modifying the established routing table in-between media stream packets, and providing synchronization for the insertion of new MSAs.

Receiving returned media stream packets from the MSAs and forward them to the next MSA (or ET) in the connection chain.

Receiving and storing returned control data.

The media connection agent is generally a function, process or equivalent operating locally in the user-plane for routing the media stream through the MSA chain.

FIG. 5 is a schematic diagram illustrating a logical view of a media stream chain in a media gateway according to a preferred embodiment of the invention. The gateway comprises a bearer control unit 102, a connection coordinator 103, a resource manager 104, a resource pool 105 of media stream applications (MSAs) and other resources.

The bearer control 102 informs the connection coordinator 103 of an incoming request for a connection, and also indicates which exchange terminal ET1 that has been selected by the far end node.

For each data stream, the connection coordinator 103 requests one of a number of media connection agents from the resource manager 104, preferably at call establishment. Alternatively, however, media connection agents may be pre-allocated and connected to respective incoming links. In this particular embodiment, the requested media connection agent 106 includes a virtual terminal (VT), and the connection coordinator 103 sets up a connection between the VT of the media connection agent 106 and the allocated incoming logical channel of the exchange terminal ET1 so that the media connection agent 106 assigned for the connection is ready to receive user plane data. The connection coordinator 103 can now, or simultaneously with the establishment of the ET1-VT connection, request the needed MSAs from the resource manager 104. The connection coordinator 103 also instructs the bearer control 102 to establish an outgoing connection by allocating an outgoing logical channel of the exchange terminal ET2.

The media connection agent 106 determines a routing table 107 based on the allocated outgoing logical channel of ET2 and the destination addresses of the pin-pointed MSAs provided by the resource manager 104 via the connection coordinator 103. Once determined, the routing table 107 can be used for routing the media stream from the incoming ET1 to the outgoing ET2 via the chain of MSAs. The MSAs are informed of the address of the assigned media connection agent 106 so that processed media stream packets from an MSA can be returned to the media connection agent 106, from which the packets subsequently are routed to the next MSA or to the outgoing exchange terminal ET2.

In this particular example, the MSA chain includes a codec application MSA1, an echo cancellation application MSA2, and optionally, a tone application MSA3.

When the call is taken down, the assigned media connection agent 106 and the associated media stream applications are returned to the resource pool 105 by the resource manager 104. Prom a resource handling point of view, the media connection agent 106 may be treated as any other resource handled by the resource manager 104.

It should be understood that the connection coordinator 103 may handle several media connection agents for different connections at the same time.

The MSAs are normally process functions that are included in the gateway as common resources that can be invoked as and when required. According to a preferred embodiment of the invention, each MSA is identified by an individual destination address with a number of different ports. By way of example, the following ports could be used:

0. Forward user data.

1. Backward user data (e.g. for data from the other direction required for echo cancellation).

2. Forward control data (e.g. for modifying the behavior of the MSA in question).

3. Forward status data.

4-7. Predefined ports starting a specific processing task in the MSA.

Each MSA has means for identifying the tasks defined by its ports, as well as means for returning requested user or control data.

Alternatively, the MSAs are data driven instead of being port driven. In that case, it is sufficient with a single MSA input port, and the task of the MSA can then be indicated by task-defining instructions provided in the media stream packets.

Preferably, the media connection agent, the media stream applications, the resource manager and the connection coordinator are all implemented in software as processes, objects, procedures, functions or similar software entities. It should though be understood that they could alternatively be implemented in hardware, or any combination of hardware and software.

According to the preferred embodiment of the invention, the MSAs and MCAs are self-contained resources. In general, it is not necessary to clear the MSAs and MCAs at system restart. Instead, they normally clear themselves when they are invoked the next time for a new call.

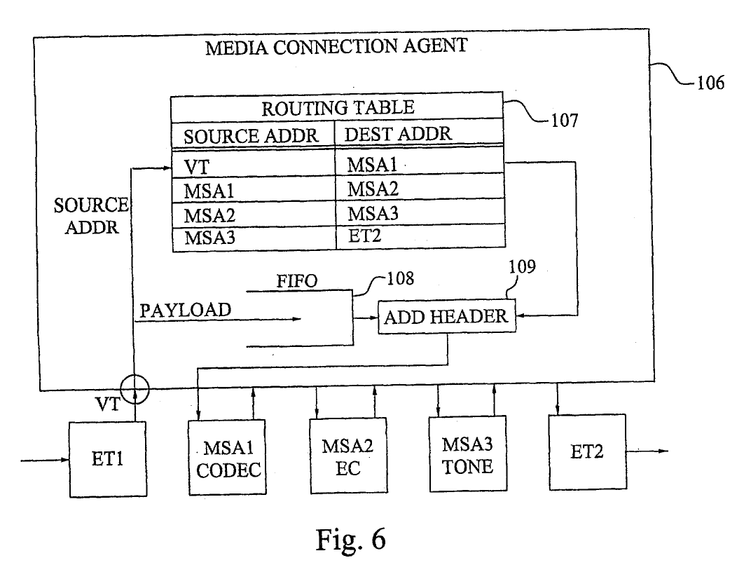

For a better understanding of how the media connection agent processes cells to be routed through the connection chain, reference is made to FIG. 6 which illustrates an example of a routing table and associated arrangements in a media connection agent according to a preferred embodiment of the invention. Typically, the software process executing the media connection agent 106 is triggered whenever a new cell arrives. At the arrival of a cell from the virtual terminal (VT), the payload is distributed to a FIFO 108 while the logic source address in the cell header is distributed to the routing table 107. The media connection agent looks through the source address entries in the routing table 107 to see if it can find an entry that matches the logic source address of the arriving cell; in this case the virtual terminal VT. Since the media connection agent 106 normally controls only one media stream, the associated routing table is often relatively small, and the media connection agent can rather quickly go through all positions in the table if necessary. The matching entry of the routing table 107 includes the destination address field of the new header. The new cell header is added to the payload stored in the FIFO 108 by the module 109, and subsequently the outgoing cell is routed to the addressed MSA; in this case the codec application MSA1. The media connection agent 106 also appends its own source address to the cell so that the addressed MSA is able to return the processed data to the media connection agent. If no matching entry is found, the cell is typically discarded and an entry is made in a history log (not shown).

Even when the media connection agent is based on a cell-switching fabric, the media connection agent may reassemble the media stream packets included in the arriving cells and perform the processing on packet level instead of cell level. However, before sending the packets through the cell switching fabric to the addressed MSA, the packets have to be segmented into cells again.

As apparent from the routing table of FIG. 6, the connection chain may easily be altered by changing appropriate parts of the routing table 107, or adding information to the table. This can be done between packets or even during processing of a packet since the packet can be put on hold in the FIFO 108 while the routing table is modified.

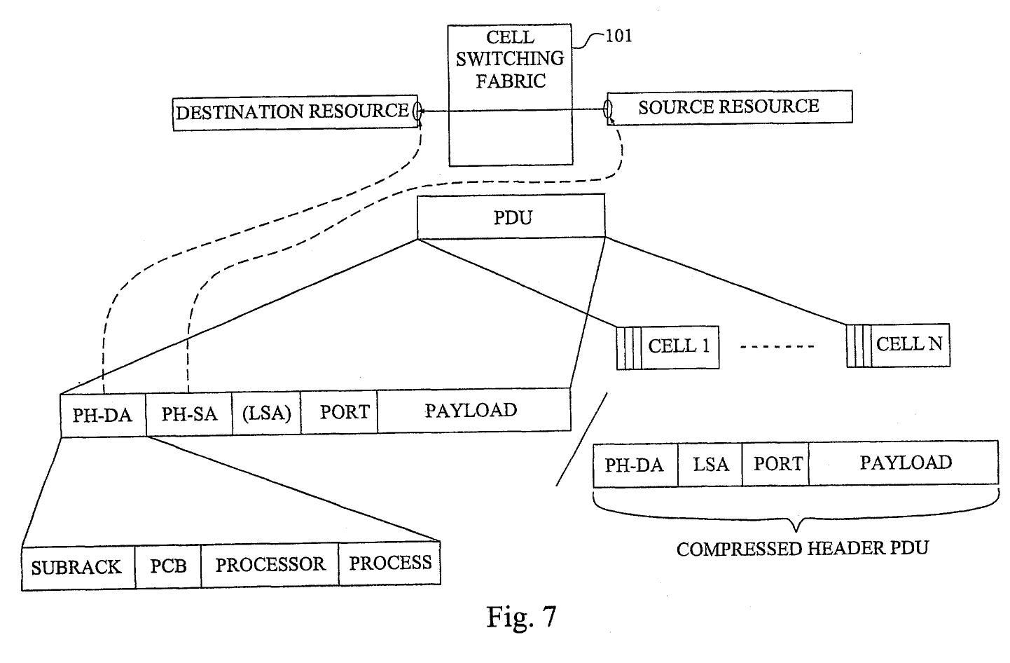

FIG. 7 is a schematic diagram illustrating the structure of a packet data unit routed between source and destination resources in a media gateway according to a preferred embodiment of the invention. The packet data unit (PDU) is transferred between a source resource and a destination resource through a cell switching fabric 101. The source and destination resources are generally media stream applications and media connection agents, or other resources.

The packet data unit (PDU) comprises a header and payload. The header includes a physical destination address (pH-DA), a physical source address (PH-SA) and a port indication (PORT). The ports may be common for the peer entities on both sides of the link. Each physical address is typically decomposed into subrack, printed circuit board (PCB) in the subrack and processor on the printed circuit board, and also includes a pointer to the MSA process to be executed by the processor.

Before traversing the cell switching fabric, the PDU is arranged into cells. A packet is generally confined to a single cell, but may be segmented into a several cells (CELL 1 to CELL N). Conventional techniques may be used to indicate the first cell (CELL 1), intermediate cells (CELL 1 to CELL N−1), and the last cell (CELL N). An additional indicator may also be used to indicate the case when the PDU is contained in a single cell.

In the preferred segmentation, the physical destination address (PH-DA) is mapped to the header of each cell. In this way, each cell is self-contained with the information needed to reach the destination resource. The physical source address is normally sent only once during a session, but can be repeated if necessary. Instead, the rather long physical source address is replaced by a logic source address (LSA) in the remaining media stream packets. The LSA is normally included in the first packet as an association. An indicator is preferably provided in each PDU to indicate whether it is a full header PDU or a compressed header PDU (without PH-SA). This means that the target MSA knows the PH-SA even though it is not provided in each packet.

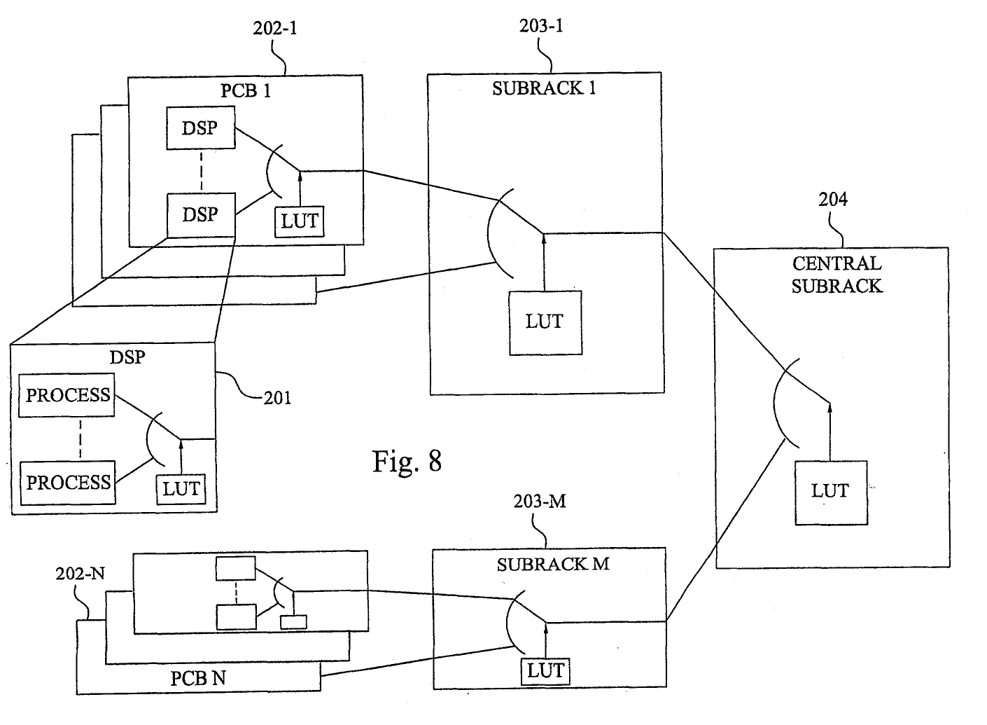

FIG. 8 is a schematic diagram illustrating an example of how the process resources can be accessed in a media gateway according to the invention. The process resources are all at the same logical level in a common resource pool, as described above. The processing hardware however is conveniently arranged in a hierarchical manner. The various requested process resources such as MSAs and MCAs are executed by digital signal processors (DSPs) or other equivalent processing units 201. The processors are arranged on printed circuit boards (PCBS) 202-1 to 202-N, which in turn are suitably arranged in subracks 203-1 to 203-M. The subracks are normally arranged in a central subrack 204. The process resources are preferably accessed by means of a multiplexing/demultiplexing function controlled by look-up tables (LUT) at each stage of the hierarchy. The multiplexing function is used when a cell is routed upwards towards the central subrack. The demultiplexing function is used when a cell is routed downwards. At each stage, the cell can be directed in the opposite direction if the lookup table indicates that the destination address is in the same multiplexing domain. At the central subrack, the cell must be re-directed and routed through another downward output. The resource manager generally attempts to find MSAs that are as close as possible to the MCA; in the same subrack or on the same printed circuit board for example.

Although the media connection agent provides an efficient and robust mechanism for routing a media stream through a local chain of media stream applications in a “connectionless” manner and significantly reduces the time required for setup and takedown, it is clear that the solution described above in connection with FIGS. 4-6 requires that the user plane data flows back and forth between the media connection agent and the various MSAs. Since the main task of the media connection agent is to relay the media stream to the next MSA in the connection chain, the switch fabric has to transport virtually the same user data twice compared to the connection-oriented prior art solution with established user plane links directly between the MSAs and ETs. Even if the media connection agent is located close to the MSAs and ETs that it interconnects, the routing of data can still be capacity demanding for the switch fabric.

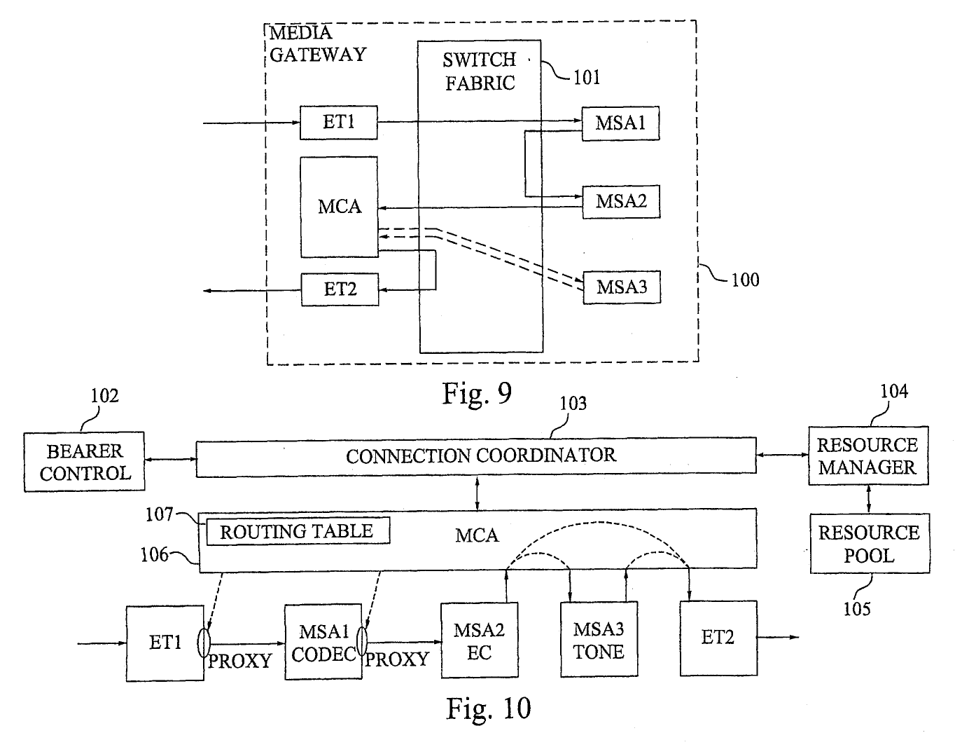

It is thus desirable to have the media connection agent setup a “connectionless” transport of a media stream directly between two MSAs or when required between an exchange terminal and an MSA. An example of how this can be accomplished by means of proxy agents will now be described with reference to FIGS. 9 and 10.

FIG. 9 is a schematic diagram illustrating a physical view of a media stream chain in a media gateway according to the currently most preferred embodiment of the invention. The physical view of FIG. 9 is similar to the physical view of FIG. 4, except that user plane data is now directly transferred from MSA1 through the switch fabric 101 to MSA2 without traversing the media connection agent MCA.

FIG. 10 is a schematic diagram illustrating a logical view of a media stream chain in a media gateway according to an alternative embodiment of the invention. The media gateway of FIG. 10 is similar to the media gateway of FIG. 5, except for the proxy agent introduced at the output of ET1 for transferring user plane data between ET1 and MSA1, and the proxy agent at the output of MSA1 for transferring data between MSA1 and MSA2.

The connection coordinator 103 is now responsible for requesting a media connection agent 106, the required MSAs as well as the necessary proxy agents from the resource manager 104. Preferably, the connection coordinator 103 assigns, to each of the relevant MSAs (and here also to the incoming ET), an individual proxy agent. As before, the media connection agent 106 has determined a routing table 107 for the connection chain, but now the media connection agent 106 also sends an individual message to each proxy agent indicating the address of the next MSA in the chain. The proxy agent of ET1 can now transfer the media stream directly from ET1 to MSA1 based on the received individual address message. In the same way, the proxy agent of MSA1 can transfer the media stream directly between MSA1 and MSA2. This basically means that the media connection agent 106 distributes the relevant parts of the central routing table 107 to the proxy agents of ET1 and MSA1 so that the proxy agents know where to send the processed media stream packets. This approach is somewhat more similar to the prior art, but still a routing-based mechanism is used and a significant reduction of the setup time can be expected.

The proxy agents are preferably, although not necessarily, implemented in software as processes, objects, procedures, functions or similar software entities and managed by the resource manager as any other resource in the resource pool 105.

In the media gateway of FIG. 10, the chain of proxy agents is discontinued at the EC application MSA2, showing that the use of distributed proxy agents transferring data directly between MSAs can be combined with a centralized mechanism for routing data between MSAs via the media connection agent.

The embodiments described above are merely given as examples, and it should be understood that the present invention is not limited thereto. Further modifications, changes and improvements which retain the basic underlying principles disclosed and claimed herein are within the scope and spirit of the invention.

1. A telecommunication gateway (100) for processing a data stream in a local chain of process functions (MSAs), characterized in that said telecommunication gateway comprises a connection chain agent (106) configured to determine a local routing table (107) for directing said data stream through said local chain of process functions, and configured to distribute at least part of said routing table (107) to the process function level for allowing transfer of said data stream directly between process functions in said local chain.

2. The telecommunication gateway according to claim 1, characterized in that said telecommunication gateway further comprises:
a number of proxy agents (PROXY); and
means (103) for assigning, to each one of a number of said process functions, an individual one of said proxy agents;
said connection chain agent (106) is configured to send an individual message to each proxy agent indicating the address of the next process function;
each proxy agent is configured to transfer said data stream from its associated process function to the next process function based on the corresponding individual address message received from said connection chain agent.

3. The telecommunication gateway according to claim 1 or 2, characterized in that said connection chain agent (106) is configured to determine said routing table (107) based on process function destination addresses provided by a resource manager (104).

4. The telecommunication gateway according to claim 1 or 2,
characterized in that said connection chain agent (106) is adapted to insert a new process function (MSA) in said local chain of process functions by altering said routing table (107).

5. The telecommunication gateway according to claim 1 or 2,
characterized in said connection chain agent (106) is configured to determine the destination address to the next process function in said local chain of process functions by searching for an entry in said routing table (107) that matches a source address carried by said data stream, whereby the matching entry includes the destination address to the next process function.

6. The telecommunication gateway according to claim 1 or 2,
characterized in that said connection chain agent (106) is configured to append its own source address to said data stream so that process functions (MSAs) are aware of the address of the assigned connection chain agent, and said connection chain agent (106) is adapted to receive said processed data stream from a process function for forwarding to a next process function in the chain.

7. The telecommunication gateway according to claim 1 or 2,
characterized in that said telecommunication gateway (100) further comprises a connection coordinator (103) for requesting said connection chain agent (106) and the required process functions (MSAs) from a resource manager (104), and said connection coordinator (103) sends the destination addresses of the requested process functions to said connection chain agent (106) to enable said connection chain agent to route said data stream through said local chain of process functions.

8. The telecommunication gateway according to claim 1 or 2,
characterized in that said telecommunication gateway is a media gateway, said data stream is a media stream and said process functions are media stream applications.

9. A method for directing a data stream through a local chain of process functions (MSAs) in a telecommunication gateway (100),
characterized in that said method comprises the steps of:
establishing a local routing table (107) for directing said data stream through said local chain of process functions; and
distributing parts of said routing table (107) to at least one proxy agent associated with a process function for allowing transfer of said data stream directly from said process function to the next process function in said local chain.

10. The method according to claim 9,
characterized in that said method further comprises the step of:
assigning, to each one of a number of said process functions, an individual proxy agent (PROXY);
said connection chain agent (106) sending an individual message to each proxy agent indicating the address of the next process function;
each proxy agent transferring said data stream from the associated process function to the next process function based on the corresponding individual address message.

11. The method according to claim 9 or 10,
characterized in that said local routing table (107) is established at least partly based on the destination addresses of said process functions.

12. The method according to claim 9 or 10,
characterized in that said method further comprises the step of inserting a new process function (MSA) in said local chain of process functions by altering said routing table (107).

13. The method according to claim 9 or 10,
characterized in that said data stream is represented by information units in said telecommunication gateway (100), and said method further comprises the step of determining the destination address to the next process function in said chain of process functions by searching for an entry in said routing table (107) that matches a source address in the header of an incoming information unit, whereby the matching entry includes the destination address to the next process function.

14. The method according to claim 13,
characterized in that said information units are packets or cells.

15. The method according to claim 9 or 10,
characterized in that said method further comprises the steps of:
said connection chain agent (106) appending its own source address to said data stream;
transferring, based on the appended source address, said data stream from a process function to said connection chain agent for forwarding to a next process function in the chain.

16. The method according to claim 9 or 10,
characterized in that said telecommunication gateway is a media gateway, said data stream is a media stream and said process functions are media stream applications.

17. A telecommunication gateway (100) for processing data streams by means of process functions (MSAs),
characterized in that said telecommunication gateway comprises a connection coordinator (103) for allocating, to each media stream, required process functions (MSAs) as well as an individual connection chain agent (106) from a resource manager (104), and for sending the destination addresses of the required process functions to the allocated connection agent (106), said connection agent (106) being configured to determine a local routing table (107) based on the destination addresses for directing the data stream through a local chain of allocated process functions.
